(19) United States
(12) Patent Application Publication
(10) Pub. No.: US 2009/0154926 A1
(43) Pub. Date: Jun. 18, 2009

(54) Highly reliable backbone video distribution architecture

(76) Inventors: Martin Birk, Holmdel, NJ (US); Kathleen Tse, Holmdel, NJ (US); Simon Zelingher, Morganville, NJ (US)

Correspondence Address: AT& T LEGAL DEPARTMENT - Monka;ATTN: PATENT DOCKETING, ROOM 2A - 207, ONE AT & T WAY, BEDMINSTER, NJ, 07921, US

(21) Appl. No.: 12/001,546

(22) Filed: Dec. 12, 2007

(51) Int. Cl. H04B 10/20; H04N 7/00

(52) U.S. Cl. 398/59; 725/114

(57) ABSTRACT

An optical network for providing a plurality of end users with video content, which includes a plurality of video head ends, each coupled to a pair of video hub offices via a plurality of diverse optical communication paths, where each hub office is coupled to a plurality of video serving offices via a pair of optical fibers arranged in a ring structure to provide a working link and a protection link, each video serving office adapted and arranged for distributing video content to a plurality of end users.

### BACKGROUND OF THE INVENTION

The present invention relates generally to optical networking, and more particularly, to an optical layer video distribution architecture for providing video via optical transport from a plurality of video super head ends across backbone networks.

The development of optical fiber communication technologies has enabled exponential growth in the capacity of backbone networks. Commercially deployed dense-wavelength-division multiplexing (DWDM) optical communication systems can now carry over 1 Tbps in a single fiber, and experimental applications have demonstrated much greater capacities.

Fiber optic distribution networks are becoming increasingly important for the provision of high bandwidth data links to commercial and residential locations. Such systems employ optical data transmitters and receivers (“transceivers”) throughout the fiber optic distribution network. These transceivers generate optical signals for optical transmission over optical fibers and receive optical signals from the fibers for processing or forwarding. In a traditional WDM system, a single optical fiber simultaneously communicates a plurality of different communication channels in light of different wavelengths. Generally, each communication channel has an assigned central wavelength and channel spacing is defined for the network. DWDM network standards have optical channels with frequency separations of 25, 50 and 100 GHZ.

Fiber optic distribution networks are becoming increasingly important for the provision of high bandwidth data links to commercial and residential locations. Such systems employ optical data transmitters and receivers (“transceivers”) throughout the fiber optic distribution network. These transceivers convert electrical signals to optical signals for optical transmission over optical fibers and receive optical signals from the fibers and convert the modulated light to electrical signals. In active optical networks, the transceivers provide optical-to-electrical-to-optical (OEO) conversion at each node in the network. These elements incorporate high speed electrical circuits in combination with active and passive optical components. Unfortunately, the need to deploy large numbers of transceivers in active optical networks can add considerable costs to the fiber optic network.

The PON architecture eliminates the requirement for OEO conversion, and hence transceivers, at each node of the fiber optic network. In this regard, PONs utilize passive optical components such as beam splitters and filters at network nodes instead of active optical components. A PON therefore has significant cost benefits when compared to active fiber optic networks. PONs have also been designed for two-way, point-to-multipoint data communication, and consequently have significant potential for “last mile” applications where both two-way data transfer and point-to-multipoint broadcast to end users are desired. Accordingly, PONs have many advantages over current access technologies and are expected to be deployed as next-generation access networks. Based on a passive point-to-multipoint network architecture, PONs can support very high transmission bit rates (hundreds of Mb/s or several Gb/s), and numerous broadband services (i.e., Ethernet access, video distribution, voice, etc).

Video distribution is subject to signal degradation from short interruptions in the video stream. This can lead to long re-synchronization times and consequent customer outages. At the IP layer, these short interruptions are common when the IP layer re-configures itself.

It would therefore be desirable to provide a network architecture for delivering video over optical links that avoids the need for layer-3 IP networking equipment between video head ends, video hub offices and video serving offices in the context of broadband video delivery to customers.

### SUMMARY OF INVENTION

In accordance with an aspect of the present invention, there is disclosed a network for providing a plurality of end users with multimedia content that eliminates the need for layer-3 IP equipment at the video head ends and video hub offices. The network generally comprises: a plurality of video head ends, each coupled to a pair of video hub offices via a plurality of diverse communication paths, where each hub office is coupled to a plurality of video serving offices, each video serving office for distributing multimedia content to a plurality of end users.

In accordance with a further aspect of the invention, an optical network for providing a plurality of end users with video content, comprises a plurality of video head ends, each coupled to a pair of video hub offices via a plurality of diverse optical communication paths, where each hub office is coupled to a plurality of video serving offices via a plurality of optical fibers, each video serving office for distributing video content to a plurality of end users.

In accordance with yet another aspect of the invention, an optical network for providing a plurality of end users with video content, comprises a plurality of video head ends, each coupled to a pair of video hub offices via a plurality of diverse optical communication paths, where each hub office is coupled to a plurality of video serving offices via a pair of optical fibers arranged in a ring structure to provide a working link and a protection link, each video serving office for distributing video content to a plurality of end users.

Another aspect of the invention provides a method for delivering multimedia content to a plurality of end users, comprising: communicating multimedia content from a plurality of video head ends to a pair of video hub offices via a plurality of diverse communication paths, where each hub office is coupled to a plurality of video serving offices, each video serving office for distributing multimedia content to a plurality of end users.

In general, the broadest aspect of the invention provides a method for delivering multimedia content to a plurality of end users, where each end user is served by at least one video serving office, by communicating the multimedia content from a plurality of video head ends to a pair of video hub offices via a plurality of diverse communication paths.

These and other advantages of the invention will be apparent to those of ordinary skill in the art by reference to the following detailed description and the accompanying drawings.

### BRIEF DESCRIPTION OF THE DRAWINGS

FIG. 1 is a schematic of an exemplary optical network in accordance with aspects of the present invention;

### DETAILED DESCRIPTION OF THE PREFERRED EMBODIMENTS

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

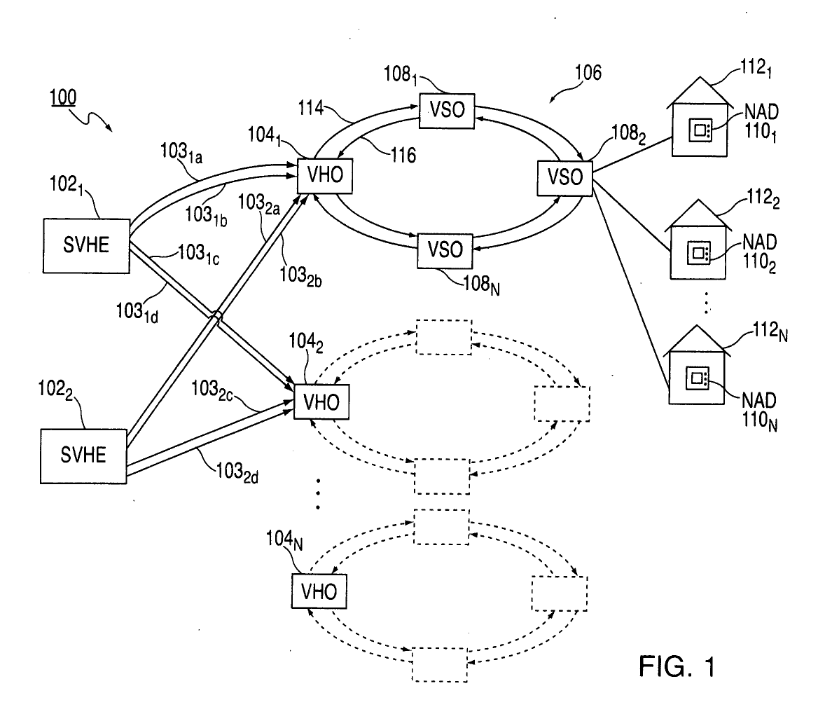

FIG. 1 is a schematic of an exemplary optical communications system for distributing video across a backbone network 100, including a pair of super video head ends (SVHE) 102₁, 102₂ that each communicate via a pair of video streams 103₁, 103₂ to a plurality of video hub offices (VHO) 104₁, 104₂, . . . 104_{N}. Thus, as will be understood by those skilled in the art, each video stream may be carried in two diverse paths from respective SVHE 102₁, 102₂ to each VHO 104_{1-N}, herein labeled as “working” and “protection” traffic, respectively. As shown, SVHE 102₁ communicates with VHO 104₁ via working link 103₁ₐ and protection link 103_{1b} while SVHE 102₂ also communicates with VHO 104₁ via working link 103₂ₐ and protection link 103_{2b}. Each VHO_{1-N} is similarly connected to SVHEs 102₁ and 102₂. An illustrative ring-shaped network 106 couples each VHO 104_{1-N} to a plurality of video serving offices (VSO) 108_{1-N} which operate as add/drop nodes that are configured to supply video multimedia content to a plurality of network access devices 110_{1-N}, for example, CATV at a user premise(s) 112_{1-N}. It will be appreciated by those skilled in the art that alternative network topologies may be employed in accordance with the invention, the depicted ring structure being merely exemplary, and further that the user premise(s) 112_{1-N} may comprise fiber-to-the-floor (FTTF), a digital subscriber line access multiplexer (DSLAM) or the like. A first fiber 114 carries optical traffic in a first direction (i.e., the “working link”), and a second fiber 116 carries optical traffic in a second direction (i.e., the “protection link”). It will also be appreciated that the “counter-rotating” ring structure as shown and described is merely exemplary, in that the working and protection traffic can travel unidirectionally. Each VSO 108_{1-N} is adapted for selectively dropping wavelength channels from fibers 114 or 116 to a network access device 110 coupled to the respective VSO 108. A plurality of amplifiers and wavelength blockers and the like may be provided between the VSOs 108_{1-N} as will be understood by those of ordinary skill in the art.

Each VSO 108 includes an apparatus for dropping selected wavelengths from a multiplexed optical signal carrying video multimedia content. Typically, downstream video is communicated in the 1550 nm band. This downstream video needs to be dropped at each VSO 108 to a respective end user 112, and such dropping of selected wavelengths is well known in the art of optical networking.

The optical network disclosed herein provides two diverse paths to ensure reliable delivery of video to end users. The inventive network architecture obviates the need for costly layer-3 (IP-layer) equipment. Using this expedient, the best of two video streams can be selected for transport, either with criteria on the transport layer (i.e., error correction considerations) or on the video layer (i.e., error rate in the video stream). The present invention has been shown and described in what are considered to be the most practical and preferred embodiments. It is anticipated, however, that departures may be made there from and that obvious modifications will be implemented by those skilled in the art. It will be appreciated that those skilled in the art will be able to devise numerous arrangements and variations which, although not explicitly shown or described herein, embody the principles of the invention and are within their spirit and scope.

We claim:

1. A network for providing a plurality of end users with multimedia content, comprising:
a plurality of video head ends, each coupled to a pair of video hub offices via a plurality of diverse communication paths, where each hub office is coupled to a plurality of video serving offices, each video serving office for distributing multimedia content to a plurality of end users.

2. The network recited in claim 1, wherein each video head end is coupled to a plurality of the video hub offices via an optical communications link.

3. The network recited in claim 2, wherein each video hub office is coupled to a plurality of video serving offices via an optical communications link.

4. The network recited in claim 2, wherein a plurality of optical links couple each video head end to each video hub office.

5. The network recited in claim 3, wherein the optical link comprises a pair of rings to provide a working link and a protection link.

6. An optical network for providing a plurality of end users with video content, comprising:
a plurality of video head ends, each coupled to a pair of video hub offices via a plurality of diverse optical communication paths, where each hub office is coupled to a plurality of video serving offices via a plurality of optical fibers, each video serving office for distributing video content to a plurality of end users.

7. The optical network recited in claim 6, wherein a plurality of optical links couple each video head end to each video hub office.

8. The optical network recited in claim 6, wherein each video hub office is coupled to the plurality of video serving offices via a pair of optical fibers arranged in a ring structure to provide a working link and a protection link

9. An optical network for providing a plurality of end users with video content, comprising:
a plurality of video head ends, each coupled to a pair of video hub offices via a plurality of diverse optical communication paths, where each hub office is coupled to a plurality of video serving offices via a pair of optical fibers arranged in a ring structure to provide a working link and a protection link, each video serving office for distributing video content to a plurality of end users.

10. The optical network recited in claim 9, wherein each video serving office includes at least one optical device for dropping selected wavelengths carrying the video content destined for each end user among the plurality of end users.

11. A method for providing a plurality of end users with multimedia content, comprising:
communicating multimedia content from a plurality of video head ends to a pair of video hub offices via a plurality of diverse communication paths, where each hub office is coupled to a plurality of video serving offices, each video serving office for distributing multimedia content to a plurality of end users.

12. A method for providing a plurality of end users with multimedia content, where each end user is served by at least one video serving office, comprising:
communicating multimedia content from a plurality of video head ends to a pair of video hub offices via a plurality of diverse communication paths.
